(19) United States
(12) Patent Application Publication
(10) Pub. No.: US 2009/0225289 A1
(43) Pub. Date: Sep. 10, 2009

(54) LITHOGRAPHIC APPARATUS AND METHODS

(75) Inventors: Johannes Petrus Martinus Bernardus Vermeulen, Helmond (NL); Jozef Petrus Henricus Benschop, Veldhoven (NL); Nicolaas Ten Kate, Almkerk (NL); Johannes Catharinus Hubertus Mulkens, Waalre (NL); Lucas Henricus Johannes Stevens, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/388,230

(22) Filed: Feb. 18, 2009

Related U.S. Application Data
(60) Provisional application No. 61/064,126, filed on Feb. 19, 2008.

(51) Int. Cl. G03B 27/52

(52) U.S. Cl. 355/30

(57) ABSTRACT

An immersion lithographic apparatus is described in which a member is provided above the surface of the substrate and the substrate table. Immersion liquid is provided between the substrate table and the substrate and the member. In an embodiment, a beam of radiation passes through the plate. In an embodiment, the member has a through hole in it through which the beam passes.

This application claims priority and benefit under 35 U.S.C. § 119(e) to U.S. Provisional Patent Application No. 61/064,126, entitled “Lithographic Apparatus and Methods”, filed on Feb. 19, 2008. The content of that application is incorporated herein in its entirety by reference.

### FIELD

The present invention relates to a lithographic apparatus and a method for providing a substrate under a projection system of an immersion lithographic apparatus as well as a method of removing a substrate from under a projection system of an immersion lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. The liquid may be distilled water (ultra pure water) although another liquid may be used. An embodiment of the present invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or liquids with nano-particle suspensions (e.g. particles with a maximum dimension of up to 10 nm). The suspended particles may or may not have a similar or the same refractive index as the liquid in which they are suspended. A liquid which may be suitable is hydrocarbon or fluorohydrocarbon, or an aqueous solution.

However, submersing the substrate or substrate and substrate table in a bath of liquid (see, for example, U.S. Pat. No. 4,509,852 means that there is a large body of liquid that must be accelerated during a scanning exposure. This requires additional or more powerful motors and turbulence in the liquid may lead to undesirable and unpredictable effects.

In an immersion apparatus, immersion fluid is handled by a fluid handling system, structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

One of the arrangements proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504. As illustrated in FIGS. 2 and 3, liquid is supplied by at least one inlet IN onto the substrate, preferably along the direction of movement of the substrate relative to the final element, and is removed by at least one outlet OUT after having passed under the projection system. That is, as the substrate is scanned beneath the element in a −X direction, liquid is supplied at the +X side of the element and taken up at the −X side. FIG. 2 shows the arrangement schematically in which liquid is supplied via inlet IN and is taken up on the other side of the element by outlet OUT which is connected to a low pressure source. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element.

A further immersion lithography solution with a localized liquid supply system is shown in FIG. 4. Liquid is supplied by two groove inlets IN on either side of the projection system PL and is removed by a plurality of discrete outlets OUT arranged radially outwardly of the inlets IN. The inlets IN and OUT can be arranged in a plate with a hole in its center and through which the projection beam is projected. Liquid is supplied by one groove inlet IN on one side of the projection system PL and removed by a plurality of discrete outlets OUT on the other side of the projection system PL, causing a flow of a thin film of liquid between the projection system PL and the substrate W. The choice of which combination of inlet IN and outlets OUT to use can depend on the direction of movement of the substrate W (the other combination of inlet IN and outlets OUT being inactive).

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

PCT patent application publication WO 2005/064405 discloses an all wet immersion lithography arrangement in which the immersion liquid is unconfined. In such a system the whole top surface of the substrate is covered in liquid. An advantage of such an arrangement is that the whole top surface of the substrate is exposed to substantially the same conditions. This may have an advantage for temperature control and processing of the substrate. In WO 2005/064405, a liquid supply system provides liquid to a gap between the projection system and the substrate. That liquid is allowed to leak over the remainder of the substrate. A barrier at the edge of a substrate table substantially prevents liquid from escaping so that it can be removed from the top surface of the substrate table in a controlled way.

### SUMMARY

Although the system of WO 2005/064405 may improve temperature control and processing of the substrate, evaporation of the immersion liquid may occur. A way to help alleviate such a problem is described in United States patent application publication no. US 2006/0119809 in which a member is provided which covers the substrate W in substantially all positions and which is arranged to have immersion liquid extending between it and the top surface of the substrate and/or substrate table which holds the substrate.

It is desirable, for example, to provide an apparatus in which the whole of the top surface of the substrate is covered in immersion fluid and in which at least a deleterious effect of providing liquid on the whole of the top surface of the substrate is addressed.

According to an aspect of the invention, there is provided an immersion lithographic apparatus comprising: a substrate table constructed to hold a substrate; a projection system configured to project a patterned radiation beam onto a target portion of a substrate; a member held substantially stationary relative to the projection system configured to allow passage therethrough of the patterned radiation beam, a surface of the member facing the substrate table; a fluid supply system for supplying an immersion fluid to a space between the projection system and the substrate and/or substrate table and to provide the immersion fluid to extend between the substrate table and/or substrate and the surface of the member; and a seal device for sealing between the surface of the member and the substrate table.

According to an aspect of the invention, there is provided an immersion lithographic apparatus comprising: a substrate table constructed to hold a substrate; a projection system configured to project a patterned radiation beam onto a target portion of a substrate; a member held substantially stationary relative to the projection system and with a through hole for the passage therethrough of the patterned radiation beam, a surface of the member facing the substrate table; a fluid supply system for supplying an immersion fluid to a space between a final element of the projection system and the substrate and/or substrate table and to provide immersion fluid to extend between the substrate table and/or substrate and the surface of the member; a first fluid removal system for removing fluid from the space; and a second fluid removal system for removing fluid from between the surface of the member and the substrate table at a position radially outwardly of the substrate.

According to an aspect of the invention, there is provided an immersion lithographic apparatus comprising: a substrate table constructed to hold a substrate; a member with a surface facing the substrate table; a pre-wetting station for providing immersion fluid onto a surface of the substrate and/or substrate table prior to the substrate/substrate table moving under the member such that the immersion fluid extends between the surface of the substrate and/or substrate table and the surface of the member facing the substrate table.

According to an aspect of the invention, there is provided an immersion lithographic apparatus comprising: a substrate table constructed to hold a substrate; a member with a surface facing the substrate table; and a fluid remover for removing fluid from a surface of the substrate and substrate table as the substrate/substrate table moves from underneath the surface of the member during movement of the substrate from under the member.

According to an aspect of the invention, there is provided an immersion lithographic apparatus comprising: a first substrate table constructed to hold a substrate; and a second substrate table constructed to hold a substrate, wherein the first and second substrate tables are releasably attachable together.

According to an aspect of the invention, there is provided a method of providing a substrate under a projection system of an immersion lithographic apparatus, the method comprising: moving a substrate on a substrate table under an elongate pre-wetting station which provides an immersion fluid on a top surface of the substrate and/or substrate table; and moving a pre-wet portion of the substrate/substrate table under a member which is held substantially stationary relative to the projection system such that immersion fluid extends between a surface of the member facing the substrate/substrate table and the substrate/substrate table.

According to an aspect of the invention, there is provided a method of removing a substrate table from under a projection system of an immersion lithographic apparatus, the method comprising: moving a substrate on a substrate table from under a member which is held substantially stationary relative to the projection system; and using a fluid removing device positioned over a portion of the substrate table which emerges as the substrate table is moved from under the member to remove fluid from the portion.

According to an aspect of the invention, there is provided an immersion lithographic apparatus comprising: a substrate table constructed to hold a substrate; a projection system configured to project a patterned radiation beam onto a target portion of a substrate; a member held substantially stationary relative to the projection system configured to allow passage therethrough of the patterned radiation beam, a surface of the member facing the substrate table; a fluid supply system for supplying a substantially incompressible immersion fluid to a space between the projection system and the substrate and/or substrate table and between the substrate table and/or substrate and the surface of the member; and a seal device for sealing between the surface of the member and the substrate table.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts a further liquid supply system for use in a lithographic projection apparatus;

FIG. 5 depicts, in cross-section, a barrier member which may be used in an embodiment of the present invention as a liquid supply system;

FIG. 6 illustrates, in cross-section, another barrier member which may be used in an embodiment of the present invention;

FIGS. 7a-c illustrate an embodiment of the present invention during substrate swap;

FIG. 8 illustrates, in plan, the embodiment of FIG. 7;

FIG. 9a illustrates, in cross-section, an embodiment of the present invention during substrate swap;

FIG. 9b illustrates, in cross-section, a variation on the FIG. 9a embodiment during substrate swap; and

FIG. 10 illustrates, in plan, the embodiment of FIG. 9a.

### DETAILED DESCRIPTION

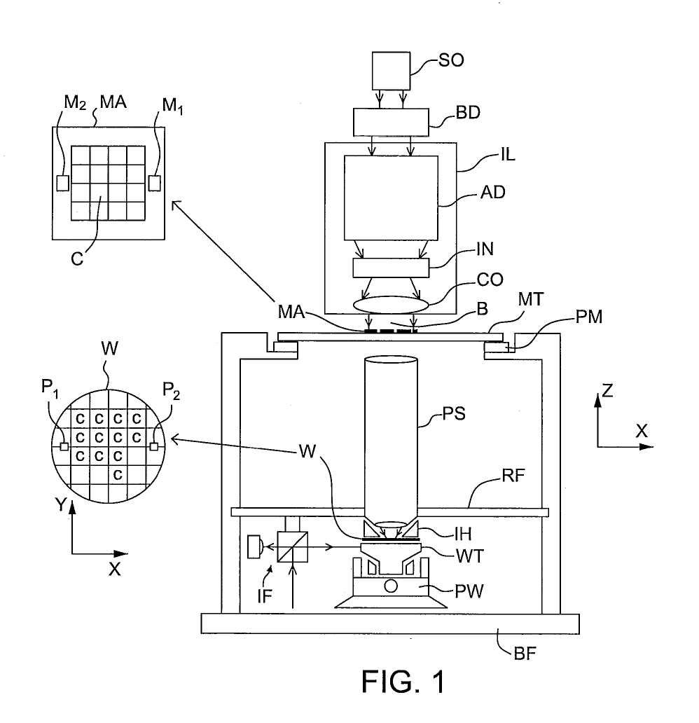

FIG. 1 schematically depicts a lithographic apparatus according to one embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device MA, the design of the lithographic apparatus, and other conditions, such as for example whether or not the patterning device MA is held in a vacuum environment. The support structure MT can use mechanical, vacuum, electrostatic or other clamping techniques to hold the patterning device MA. The support structure MT may be a frame or a table, for example, which may be fixed or movable as required. The support structure MT may ensure that the patterning device MA is at a desired position, for example with respect to the projection system PS. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”. The projection system may be held by a metrology frame RF. The projection system may be held by a base frame BF. The base frame RF may support the metrology frame RF. The metrology frame RF may be supported by, and dynamically isolated from, the base frame BF using, for example, one or more isolation mounts.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source SO and the lithographic apparatus may be separate entities, for example when the source SO is an excimer laser. In such cases, the source SO is not considered to form part of the lithographic apparatus and the radiation beam is passed from the source SO to the illuminator IL with the aid of a beam delivery system BD comprising, for example, suitable directing mirrors and/or a beam expander. In other cases the source SO may be an integral part of the lithographic apparatus, for example when the source SO is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator IL can be adjusted. In addition, the illuminator IL may comprise various other components, such as an integrator IN and a condenser CO. The illuminator IL may be used to condition the radiation beam, to have a desired uniformity and intensity distribution in its cross-section. Similar to the source SO, the illuminator IL may or may not be considered to form part of the lithographic apparatus. For example, the illuminator IL may be an integral part of the lithographic apparatus or may be a separate entity from the lithographic apparatus. In the latter case, the lithographic apparatus may be configured to allow the illuminator IL to be mounted thereon. Optionally, the illuminator IL is detachable and may be separately provided (for example, by the lithographic apparatus manufacturer or another supplier).

The radiation beam B is incident on the patterning device (e.g., mask) MA, which is held on the support structure (e.g., mask table) MT, and is patterned by the patterning device MA. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion C in a single dynamic exposure, whereas the length of the scanning motion determines the height (in the scanning direction) of the target portion C.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

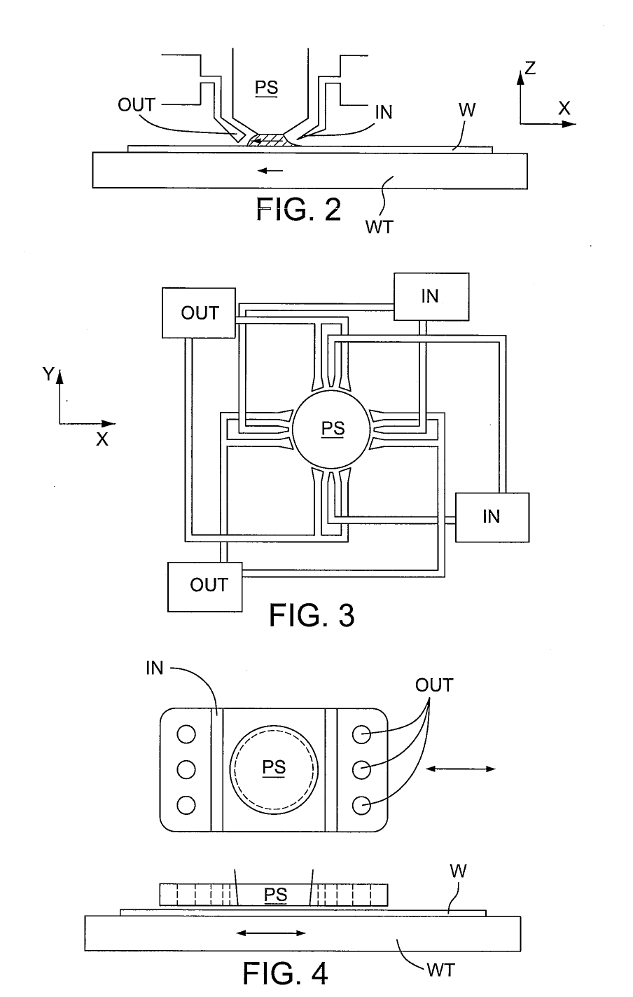

Traditional arrangements for providing liquid between a final element of the projection system PS and the substrate can be classed into two general categories. These are the bath type arrangement in which the whole of the substrate W and optionally part of the substrate table WT is submersed in a bath of liquid and the so called localized immersion system in which liquid is substantially only provided to a localized area of the substrate. In the latter category, the space filled by liquid is smaller in plan than the top surface of the substrate and the area filled with liquid remains stationary relative to the projection system PS while the substrate W moves underneath that area. A further arrangement, to which an embodiment of the present invention is mainly directed, is the all wet solution in which the liquid is unconfined. In this arrangement, substantially the whole top surface of the substrate and all or part of the substrate table is covered in immersion liquid. The depth of the liquid covering at least the substrate is small. The liquid may be a film, such as a thin film, of liquid on the substrate. Any of the liquid supply devices of FIGS. 2-5 can also be used in such a system; however, their sealing features are not present, are not activated, are not as efficient as normal or are otherwise ineffective to seal liquid to only the localized area. Four different types of localized liquid supply systems are illustrated in FIGS. 2-5. The liquid supply systems disclosed in FIGS. 2-4 were described above.

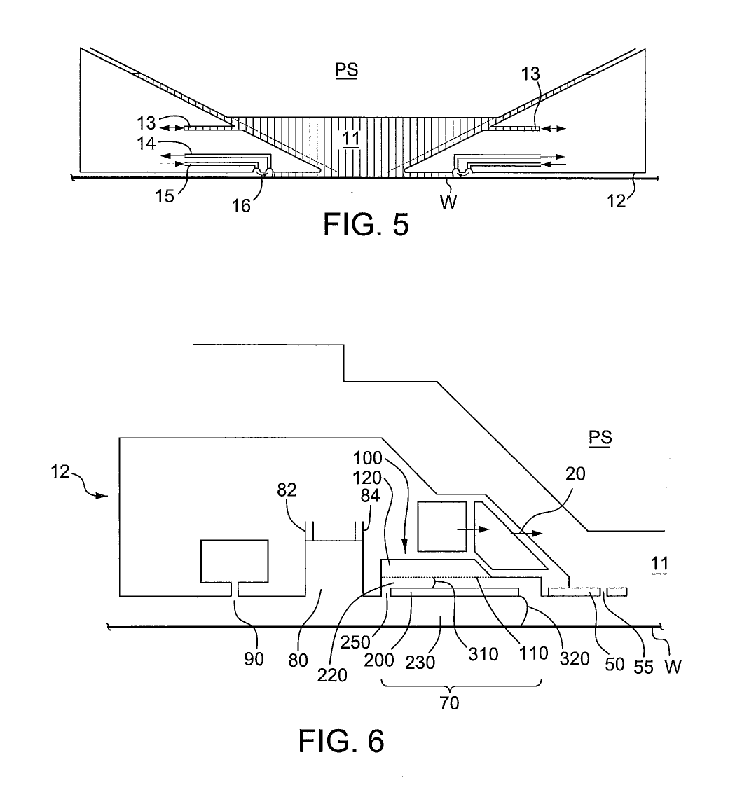

FIG. 5 schematically depicts a localized liquid supply system with a barrier member 12, which extends along at least a part of a boundary of the space 11 between the final element of the projection system PS and the substrate table. The barrier member 12 is substantially stationary relative to the projection system PS in the XY plane though there may be some relative movement in the Z direction (in the direction of the optical axis). In an embodiment, a seal is formed between the barrier member 12 and the surface of the substrate W and may be a contactless seal such as a gas seal or fluid seal.

The barrier member 12 at least partly contains liquid in the space 11 between a final element of the projection system PS and the substrate W. A contactless seal, such as a gas seal 16, to the substrate W may be formed around the image field of the projection system PS so that liquid is confined within the space 11 between the substrate surface and the final element of the projection system PS. The space 11 is at least partly formed by the barrier member 12 positioned below and surrounding the final element of the projection system PS. Liquid is brought into the space 11 below the projection system PS and within the barrier member 12 by liquid inlet 13 and may be removed by liquid outlet 13. The barrier member 12 may extend a little above the final element of the projection system PS and the liquid level rises above the final element so that a buffer of liquid is provided. The barrier member 12 has an inner periphery that at the upper end, in an embodiment, closely conforms to the shape of the projection system PS or the final element thereof and may, e.g., be round. At the bottom, the inner periphery closely conforms to the shape of the image field, e.g., rectangular though this need not be the case.

The liquid is contained in the space 11 by the gas seal 16 which, during use, is formed between the bottom of the barrier member 12 and the surface of the substrate W. The gas seal 16 is formed by gas, e.g. air or synthetic air but, in an embodiment, N₂ or another inert gas, provided under pressure via inlet 15 to the gap between barrier member 12 and substrate W and extracted via outlet 14. The overpressure on the gas inlet 15, vacuum level on the outlet 14 and geometry of the gap are arranged so that there is a high-velocity gas flow inwards that confines the liquid. The force of the gas on the liquid between the barrier member 12 and the substrate W contains the liquid in a space 11. Those inlets/outlets may be annular grooves which surround the space 11. The annular grooves may be continuous or discontinuous. The flow of gas is effective to contain the liquid in the space 11. Such a system is disclosed in United States patent application publication no. US 2004-0207824.

Other arrangements are possible and, as will be clear from the description below, an embodiment of the present invention may use any type of localized liquid supply system as the liquid supply system.

One or more localized liquid supply systems seal between a part of the liquid supply system and a substrate W. Relative movement of that part of the liquid supply system and the substrate W may lead to breakdown of the seal and thereby leaking of liquid. The problem may be more significant at high scan velocities. An increased scan velocity is desirable because throughput increases.

FIG. 6 illustrates a barrier member 12 which is part of a liquid supply system. The barrier member 12 extends around the periphery (e.g., circumference) of the final element of the projection system PS such that the barrier member (which is sometimes called a seal member) is, for example, substantially annular in overall shape. The projection system PS may not be circular and the outer edge of the barrier member 12 may also not be circular so that it is not necessary for the barrier member to be ring shaped. The barrier could also be other shapes so long as it has an opening through which the projection beam may pass out from the final element of the projection system PS. The opening may be centrally located. Thus during exposure the projection beam may pass through liquid contained in the opening of the barrier member and onto the substrate W. The barrier member 12 may be, for example, substantially rectangular and is not necessarily the same shape as the final element of the projection system PS is at the height of the barrier member 12.

The function of the barrier member 12 is at least partly to maintain or confine liquid in the space between the projection system PS and the substrate W so that the projection beam may pass through the liquid. The top level of liquid is simply contained by the presence of the barrier member 12 and the level of liquid in the space is maintained such that the liquid does not overflow over the top of the barrier member 12. A seal is provided between the bottom of the barrier member 12 and the substrate W. In FIG. 6 a seal device is configured to provide a contactless seal and is made up of several components. Working radially outwardly from the optical axis of the projection system PS, there is provided a (optional) flow plate 50 which extends into the space (though not into the path of the projection beam) which helps maintain substantially parallel flow of the immersion liquid out of outlet 20 across the space. The flow control plate has through holes 55 in it to reduce the resistance to movement in the direction of the optical axis of the barrier member 12 relative to the projection system PS and/or substrate W.

Radially outwardly along the bottom of the barrier member 12 there may be provided an outlet 60 which provides a flow of liquid in a direction substantially parallel to the optical axis towards the substrate. This flow of liquid is used to help fill a gap between the edge of the substrate W and the substrate table WT which supports the substrate. If the gap is not filled with liquid, bubbles may be included in the liquid in the space between the projection system PS and the substrate W when an edge of the substrate W is passed under the seal. This is undesirable as it may lead to deterioration of the image quality.

Radially outwardly of the outlet 60 may be an extractor assembly 70 to extract liquid from between the barrier member 12 and the substrate W and/or the substrate table WT. The extractor 70 will be described in more detail below and forms part of the contactless seal which is created between the barrier member 12 and the substrate W.

Radially outwardly of the extractor assembly 70 may be a recess 80. The recess is connected through an inlet 82 to the atmosphere. The recess if connected via an outlet 84 to a low pressure source. Radially outwardly of the recess 80 may be a gas knife 90. An arrangement of the extractor, recess and gas knife is disclosed in detail in United States patent application publication no. US 2006/0158627. However, in that document the arrangement of the extractor assembly is different.

The extractor assembly 70 comprises a liquid removal device or extractor or inlet 100 such as the one disclosed in United States patent application publication no. US 2006-0038968, incorporated herein its entirety by reference. Any type of liquid extractor may be used. In an embodiment, the liquid removal device 100 comprises an inlet which is covered in a porous material 110 which is used to separate liquid from gas to enable single-liquid phase liquid extraction. A chamber 120 downstream of the porous material 110 is maintained at a slight under pressure and is filled with liquid. The under pressure in the chamber 120 is such that the meniscuses formed in the holes of the porous material prevent ambient gas from being drawn into the chamber 120 of the liquid removal device 100. However, when the porous surface 110 comes into contact with liquid there is no meniscus to restrict flow and the liquid can flow freely into the chamber 120 of the liquid removal device 100. The porous surface 110 extends radially inwardly along the barrier member 12 (as well as around the space). The rate of extraction through the porous surface 110 varies according to how much of the porous material 110 is covered by liquid.

During scanning of the substrate W (during which the substrate moves under the barrier member 12 and projection system PS) the meniscus can be drawn either towards or away from the optical axis by a drag force applied by the moving substrate. This can lead to liquid loss which may result in evaporation of the liquid, cooling of the substrate, and consequent shrinkage and overlay errors as described above. Liquid stains may also or alternatively be left behind from interaction between the liquid droplets and resist photochemistry. A plate 200 may be provided between the liquid removal device 100 and the substrate W so that the function of liquid extraction and the function of meniscus control can be separated from one another. The barrier member 12 may be optimized for each.

The plate 200 is a divider, or any other element, which has the function of splitting the space between the liquid removal device 100 and the substrate W into two channels. The two channels are: an upper channel 220 and a lower channel 230. The upper channel 220 is between the upper surface of the plate 200 and the liquid removal device 100. The lower channel 230 is between the lower surface of the plate 200 and the substrate W. Each channel is open, at its radially innermost end, to the space 11. The thickness of the plate is not critical. Although as illustrated in FIG. 6 the upper channel 220 extends horizontally, this is not necessarily the case. The reason for the upper channel 220 extending horizontally in FIG. 6 is because of the structural arrangement of the components. However, the upper channel 220 could also extend vertically or any where between horizontally and vertically. The gravitational pressure on the liquid in the upper channel 220 is very low and, if necessary, can be counteracted by applying an under pressure, for example through liquid removal device 100 itself or through another passage such as breathing holes 250 described below.

In an embodiment, the upper channel 220 between the liquid removal device 100 and the plate 200 is narrower than the lower channel 230 between the plate 200 and the substrate W. The lower channel is between 250 mm and 50 μm high, or between 100 and 60 μm. The height of the lower channel depends, in a non-limiting list, on design (for example for viscous drag length from flow pattern), fluid parameters (such as viscosity, density, surface tension) and surface properties (which may include the contact angle resulting from binding energy surface/liquid and liquid surface tension). The upper channel 220 has a stronger capillary action, for instance by making it 2 to 3 times narrower than the lower channel. Alternatively or additionally, the upper channel 220 may have a surface (for example a coating) which is more liquidphillic than a surface of the lower channel 230. However, the upper channel 220 may be higher than the lower channel 230. If the upper channel 220 is too narrow, liquid does not flow in that channel because the frictional resistance is too large. The meniscus may be pinned because it is fully loaded with hydrodynamic forces. Thus, if the upper channel 220 is made higher, for example in the region of 150 μm, than the lower channel 230 which could be perhaps 60 μm, these difficulties may be overcome. Above a channel height of 250 μm the capillary action is reduced. In order to promote capillary action, the upper channel 220 could be made liquidphillic or a height step close to the meniscus between the plate 200 and the liquid removal device 100 may be made such that the channel radially inwardly is higher than radially outwardly.

An under pressure may be applied in the upper channel 220, rather than leaving it open to the atmosphere through breathing holes 250 e.g. through the holes 250. In this way the upper channel 220 may be made wider.

With the plate 200, there are two meniscuses 310, 320. A first meniscus 310 is positioned above the plate 200. It extends between the porous surface 110 and the top surface of the plate 200. A second meniscus 320 is positioned underneath the plate 200. It extends between the plate 200 and the substrate W. In this way the extractor assembly 70 may be optimized for control of the first meniscus 310 for optimum extraction of liquid and/or for positional control of the second meniscus 320. Thus the viscous drag length for the second meniscus 320 is reduced. The characteristics, in particular of the plate 200, are optimized to make it energetically favorable for the second meniscus 320 to remain adhered to the plate 200. So, the scan speed of the substrate W beneath the barrier member 10 may be increased. Capillary forces acting on the second meniscus 320 are outwards and are balanced by an under pressure in the liquid adjacent the second meniscus 320 so that the second meniscus 320 stays substantially still. Higher loading on the second meniscus 320, for example by viscous drag and inertia, results in a lowering of the contact angle of the second meniscus 320 with the surface.

One or more breathing holes 250 are provided at the radially outward most end of the plate 200. The first meniscus 310 is free to move inwardly and outwardly beneath the porous material 110 so that the extraction rate of the liquid removal device 100 may vary according to how much of the porous material 110 is covered by liquid. As illustrated in FIG. 6 the second meniscus 320 adheres to a lower inward edge of the plate 200.

In FIG. 6 the inner most bottom edge of the plate 200 is provided with a sharp edge so as to pin the second meniscus 320 substantially in place. The radius of the edge is, in an embodiment, less than 0.1 mm, less than 50 μm, less than 20 μm or about 10 μm.

An alternative or additional way of pinning the second meniscus 320 is to change the surface properties of the surface of the plate 200 to which the second meniscus 320 adheres. For example, a change from a liquidphilic to a liquidphobic surface in a radially outward direction on the plate 200 could also result in pinning of the second meniscus 320 at that change because the shape of the meniscus will need to invert for it to pass from the liquidphilic to the liquidphobic surface. Additionally or alternatively, the second meniscus 320 may be pinned by changing the surface of the plate 200 from a rough to a smooth surface. When fully wetted the rough surface can act as a meniscus trap. If the surface is not fully wetted and the liquid is only on the peaks of the roughness, a rough surface can be liquidphobic such as in the so called lotus effect. Additionally, electro wetting could be used to locally trap the meniscus. This has an advantage in that it can be turned on and off.

Although not specifically illustrated in FIG. 6, the liquid supply system has an arrangement to deal with variations in the level of the liquid. This is so that liquid which builds up between the projection system PS and the barrier member 12 can be dealt with and does not spill. Such a build-up of liquid might occur during relative movement of the barrier member 12 to a projection system PS described below. One way of dealing with this liquid is to provide the barrier member 12 so that it is very large so that there is hardly any pressure gradient over the periphery (e.g., circumference) of the barrier member 12 during movement of the barrier member 12 relative to the projection system PS. In an alternative or additional arrangement, liquid may be removed from the top of the barrier member 12 using, for example, an extractor such as a single phase extractor similar to the extractor 120. An alternative or additional feature is a liquidphobic or hydrophobic coating formed in a band around the top of the barrier member 12 surrounding the opening and/or around the last optical element of the projection system PS, radially outward of the optical axis of the projection system. The liquidphobic or hydrophobic coating helps keep the immersion liquid in the space.

A difficulty with a localized area liquid supply system is that it is difficult to contain all of the immersion liquid. Thus, avoiding leaving some liquid behind on the substrate as the substrate moves under the projection system is difficult. In order to avoid liquid loss, the speed at which the substrate moves under the liquid supply system should be limited due to potential bubble entrapment at the advancing meniscus. This is particularly so with an immersion liquid capable of generating high values of NA in the immersion lithography apparatus because they tend to have a lower surface tension than water as well as a higher viscosity. Breakdown speed of a meniscus scales with surface tension over viscosity so that a high NA liquid may be far harder to contain. Leaving liquid behind on the substrate in only certain areas may lead to a temperature variation throughout the substrate due to evaporation of the immersion liquid left behind and thus leading to overlay errors. Also or alternatively, as the immersion liquid evaporates, it is possible that a drying stain can be left behind on the substrate W. Also or alternatively, the liquid may diffuse into the resist on the substrate leading to inconsistencies in the photochemistry of the top surface of the substrate. Although a bath type solution (i.e. where the substrate is submerged in a container of liquid) may alleviate many of these problems, substrate swap in the immersion apparatus may be particularly difficult with a bath type solution. An embodiment of the present invention addresses one or more of these issues, or other issues not mentioned here, as will be described below.

In an embodiment of the present invention, substantially the whole of the top surface of the substrate W is covered in immersion liquid throughout imaging of the substrate. Furthermore, a member is positioned above the substrate. The member has a surface which faces the substrate and substrate table. Immersion fluid (in particular fluid which is not a gas, such as an incompressible fluid) extends between the top surface of the substrate and/or substrate table and the surface of the member facing the substrate and/or substrate table. This ensures that no evaporation of liquid can take place from the surface of the substrate. It also ensures that no surface waves can develop on the liquid, thereby causing deleterious vibrations. Furthermore contaminants may be prevented from entering the system and may be flushed out by an outward flow of liquid. Furthermore no gas knife is needed and which can be a source of contamination.

Liquid is removed from between the member and the substrate table by one or more extractors positioned either in the substrate table, the carrier of the substrate table or in the member itself. Due to limited flow rate, an extensive drain at the edge of the substrate table, or formed in the surface of the substrate table WT surrounding the substrate (when present on the substrate table WT), is not required. This may result in a smaller footprint of the substrate table. The extractor could be a single phase extractor, with or without a gas knife, or a gas drag principle extractor such as used in the barrier member disclosed in U.S. patent application Ser. No. 11/987,569, filed Nov. 30, 2007.

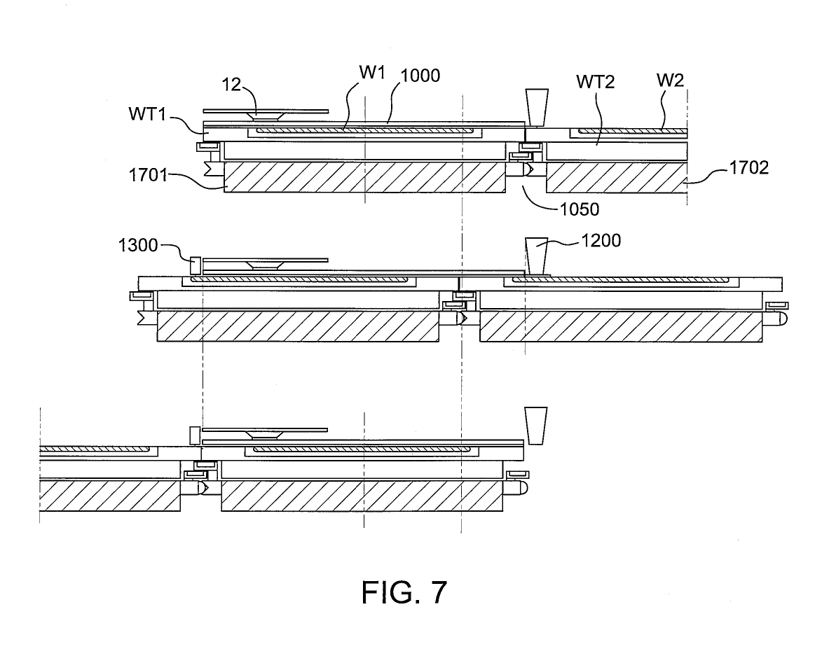

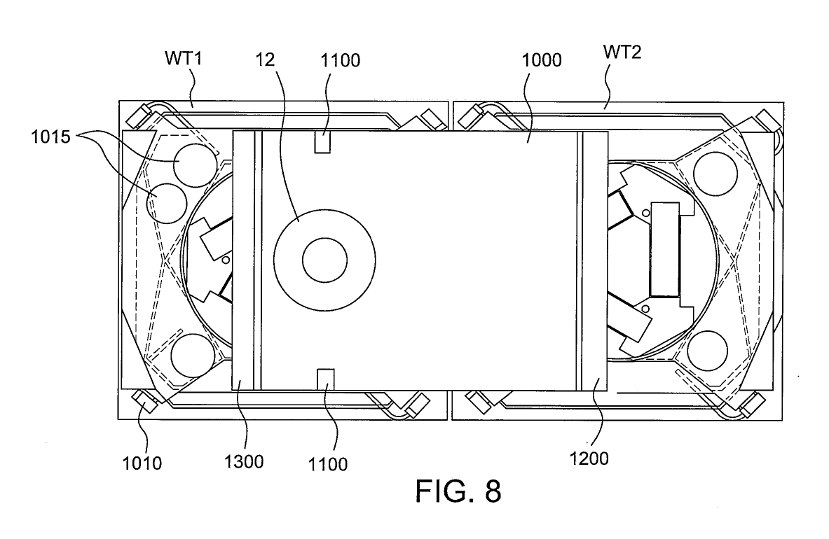

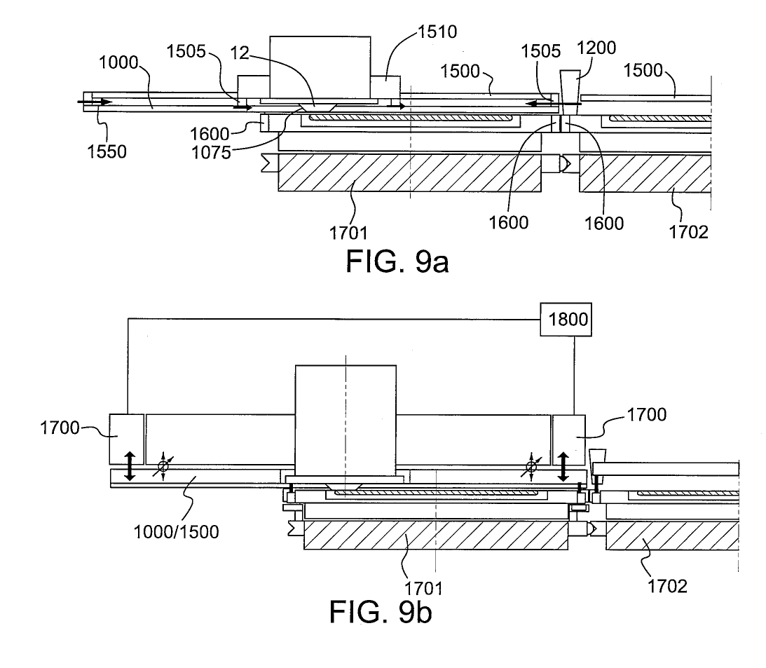

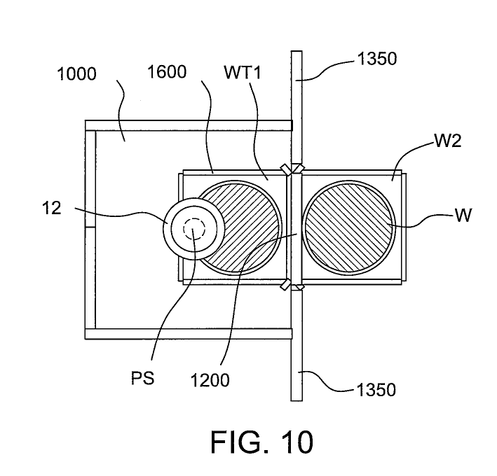

In an embodiment illustrated in FIGS. 7 and 8, the member is fixed in position relative to the substrate and substrate table during imaging. The projection beam passes through the member onto the substrate. Therefore, at least part of the member 1000 is transparent to radiation with a wavelength of the projection beam. In the embodiment illustrated in FIGS. 9 and 10, the member is substantially stationary in position relative to the projection system PS. The projection beam passes through a through hole 1075 in the member 1000 onto the substrate W. As will become clear, the two systems have similarities, particularly in the way in which replacement of a first substrate underneath the projection system with a second substrate is accomplished. Also as will become clear, the types of barrier member illustrated in FIGS. 2-6 and other types of liquid supply system can be used in these embodiments.

As illustrated in cross-section in FIG. 7a, a member 1000 is used. The member 1000 is in the form of a plate. The member 1000 is fixed relative to the substrate table WT (so called chuck or mirror block) during imaging of the substrate W. In an embodiment, a clamping mechanism is provided to attach the member 1000 to the substrate table WT during imaging. This can be accomplished, for example, by using a clamping mechanism mounted on the substrate table WT or mounted on the member 1000. The clamping mechanism may be in the form of a vacuum or electrostatic attachment device, for example.

A gap exists between the member 1000 and the substrate table WT and substrate W. This gap is filled with immersion liquid. The immersion liquid therefore extends between the top surface of the substrate table WT and substrate W and the surface of the member 1000 facing the substrate table WT and substrate W. Therefore, the member 1000 can be thought of as floating on a film of liquid.

A barrier member 12 is used to provide liquid between a final element of the projection system PS and a surface of the member 1000 opposite to the surface of the member 1000 which faces the substrate table WT and substrate W. The barrier member 12 can be of any type. In particular the barrier member 12 can be of the types illustrated in FIGS. 5 and 6. However, any type of barrier member 12 can be used. Particularly suitable barrier members are those which provide liquid to a localized area. That is, the barrier members provide liquid to an area, in plan, which is smaller than the area, in plan, of the substrate W.

In an embodiment, the immersion liquid provided by the barrier member 12 and the immersion liquid between the member 1000 and substrate table WT is the same. The transparent part of the member 1000 may have a refractive index which closely matches to within 0.05-0.1% that of the immersion liquid provided by the barrier member 12 and/or between the member 1000 and substrate table WT. The member 1000 may have a width equal to or less than the substrate table WT or the distance between a seal device (as further discussed below) located at opposing sides of the substrate table WT.

The member 1000 may, for example, be or comprise a glass or quartz plate with a thickness of selected from between about 100 μm and about 1000 μm. In an embodiment, the thickness of member 100 is selected from the range of 500 μm to 800 μm. The plate is desirably made as thin as possible but does need to have some thickness so as to avoid major deflection and handling issues. The member 1000 must be transparent to the radiation used. If radiation with a wavelength of 193 nm is used, the plate could be made, for example, from quartz.

An advantage of providing the member 1000 in the embodiment of FIG. 7 is that the top surface of the member 1000 (i.e. that which faces the projection system PS) can be provided with a surface (for example with a coating) which is ideally suited for the barrier member 12. In particular, a coating can be chosen which is advantageous in terms of containment of liquid by the barrier member 12. For example, the top surface of the member 1000 could be coated with a liquidphobic material (i.e. a material with which the immersion liquid has a contact angle of more than 70°, more than 90°, more than 100°, more than 110°, more than 120° or more than 130°). As the bottom surface of the member 1000 is in contact with immersion fluid, it may have a surface with a high contact angle (i.e. more than 70°, more than 90°, more than 100°, more than 110°, more than 120° or more than 130°). It is desirable for the bottom surface of the member to be liquidphobic as this reduces friction between the immersion liquid and the bottom surface of the member 1000.

A liquid supply device (separate from the barrier member 12) may be provided to supply liquid to the gap between the member 1000 and the substrate table WT for use during imaging. Such a liquid supply device may provide liquid through the member 1000 or through the substrate table WT. In an embodiment, a radially outward flow is caused during imaging. Such a radially outward flow is advantageous from a defectivity point of view. This may be particularly so if the top surface of the substrate table WT and/or the substrate W are not all co-planar. For instance, the substrate W may be placed in a recess in the substrate table WT. In that instance a liquid supply device may be provided to provide liquid to that recess. Such a liquid supply device could be capable of generating a flow of liquid across the surface of the substrate W. This has an advantage in terms of temperature control, leaching of resist and/or top coat from the substrate W, etc. Particularly in the case of the top surface of the substrate table WT and substrate W being co-planar, a liquid supply device to provide liquid during imaging to the gap may not be necessary. The gap may be filled with liquid during substrate swap as described below.

A seal device may be provided between the substrate table WT and the member 1000. Such a seal device is provided around the periphery (e.g., circumference) of the substrate W. The seal device may be arranged, for example, to provide a contactless seal. The contactless seal device may, for example, be similar to the contactless seal device on the bottom of the barrier member 12 described above in relation to FIG. 5. It is not necessary to have a seal device. This is because the film of liquid between the member 1000 and the top surface of the substrate table WT is relatively thin. Therefore, the liquid may be held in place by capillary forces (depending on contact angle). Also during imaging there is substantially no relative movement between the member 1000 and the substrate table WT.

If a liquid supply system is used to provide liquid to the gap between the substrate table WT and the member 1000, then a liquid removal system may be necessary to remove liquid from the gap. The liquid removal system may be incorporated into the above seal device or may be totally separate. The contactless seal device used in the barrier members of FIGS. 5 and 6 is suitable for the dual purpose of sealing and removing liquid.

The position of a substrate table in lithographic apparatus may be measured in two conventional ways. One way is to provide one or more mirrors on the edge of the substrate table and to use one or more laser interferometers to judge the position of the substrate table. Such a position measurement system is well suited to an embodiment of the present invention because the presence of the member 1000 does not interfere with such a system. A different position measurement system to measure the position of the substrate table WT is to use one or more grid plates which are positioned above the substrate table. One or more sensors and/or lasers mounted on the top surface (desirably at an outer edge) of the substrate table WT then interacts with the grid plate above the substrate table thereby to derive the position of the substrate table relative to the grid plate (such a system generally known as an encoder). The relative position of the grid plate to the projection system PS is known so that the position of the substrate table relative to the projection system PS can then be calculated. The grid plate may be part of a grid plate measurement system. The grid plate measurement system may have an associated controller and actuating system. Together these features may operate as a positing system to detect the position of the substrate table relative to the projection system and control the relative movement and/or position of the substrate table relative to the projection system.

With the presence of the member 1000 on top of the substrate table it is desirable, when the grid plate measurement system is used, to ensure that this can still function. As is illustrated in FIG. 8, it is possible to optimize the shape of the member 1000 in plan view and/or the length and/or width of the member 1000 so that the member 1000 is small enough so that it does not interfere with the laser and/or sensor 1010 of the grid plate measurement system. That is, the member 1000 may be made small enough so that it covers one or more other sensors such as a transmission image sensor (TIS), an interferometric wavefront measurement sensor (ILIAS) and/or spot sensor 1015 but that it does not block the laser and/or sensor 1010 of the grid plate measurement system. That is, the grid plate measurement system laser and/or sensor 1010 can be positioned at the outer edge of the substrate table WT at a position which is not covered by the member 1000. A suitable location for the grid plate measurement system is each of the ears at the corners of the substrate table WT. Alternatively or additionally, the member 1000 may be transparent to the wavelength of radiation used by the grid plate measurement system. Then the beam of laser 1010 and the beam detected by sensor 1010 of the grid plate measurement system can pass through the member 1000. In that case the presence of the member 1000 should be taken into account when calculating the position of the substrate table WT relative to the projection system PS.

In use, once the member 1000 is in position above the substrate table WT and clamped in place, the substrate table WT moves in unison with the member 1000 beneath the projection system PS. Imaging of the substrate W is then possible as normal by movement of the substrate W under the projection system PS. Substantially the whole of the top surface of the substrate W is covered in immersion liquid (which is present in the gap). Thereby the substrate W has substantially the same and constant conditions applied over its surface. Furthermore, because it is possible to have a coating on the top surface of the member 1000 the substrate W can move quickly under the projection system PS without substantial leaking of immersion liquid from the barrier member 12. Thus, all areas of the substrate W can be imaged. A high velocity between the projection system PS and the substrate W is possible without substantial leaking of immersion liquid. Thus, throughput may be increased. At the same time, as processing conditions between different parts of the substrate remain substantially constant, overlay performance may be improved.

As will be clear from FIGS. 7a-7c, the same member 1000 is used for imaging of different substrates W positioned on different substrate tables. FIGS. 7a-7c illustrate how the substrate swap is achieved. FIGS. 7a-7c should be considered in conjunction with FIG. 8. The location of the member 1000, substrate tables and other structures in FIG. 8 is similar to their position in FIG. 7b in that a first substrate table WT1 is moving away from under the projection system PS and a second substrate table WT2 is moving into position to replace the first substrate table WT1.

As is illustrated in FIG. 7a, the second substrate WT2 (or carrier 1702 of the second substrate table WT2) which is holding the second substrate W2 is coupled to the first substrate WT1 (or carrier 1701 of the first substrate table WT1). This can occur prior to movement of substrate WT1 from under the projection system PS. A releasable coupling system 1050 is used. The coupling system fixes the two substrate tables WT1, WT2 together so that they move in unison. The coupling system is optional and movement in unison may in addition or alternatively be accomplished by careful positional control of the two substrate tables WT1, WT2. The coupling system 1050 can comprise components on both the first and second substrate tables WT1, WT2 or only on the first substrate WT1 or only on the second substrate table WT2. Any type of coupling system may be used. For example, a mechanical interlock may be involved or an electromagnetic or vacuum suction actuated interlock may be used. Any other type of coupling system can be used. Any combination of these coupling systems may used. The coupling system desirably includes a damping system so that any collision or hard coming together between the two substrate tables WT1, WT2 is dampened. Thus the risk of damage may be reduced. More generally, the coupling system may be an actuating system comprising one or more actuators.

Before or after the two substrate tables WT1, WT2 are coupled together the member 1000 is gripped so that its position relative to the projection system PS is substantially stationary. This gripping can be done by a gripper 1100, for example a vacuum chuck, which is attached, for example, to the metrology frame RF. Alternatively or additionally, the gripper 1100 can be attached to other items, for example to the barrier member 12, to the projection system PS or to the base frame BF or the pre-wetter 1200 and/or dryer 1300 (further described below). Once the member 1000 has been gripped, the first substrate table WT1 can release the member 1000 (if it had previously held it) and can move from under the member 1000.

As is illustrated in FIGS. 7 and 8, a pre-wetter 1200 and a dryer (fluid or liquid remover) 1300 are provided on either side of the member 1000 in a plane substantially co-planar to the top surface of the substrate W. The pre-wetter 1200 and/or dryer 1300 may be fixed in position. Alternatively the pre-wetter 1200 and/or dryer 1300 may be moveable in and out of position during substrate swap and during exposure. The pre-wetter 1200 and/or dryer 1300 may be independently moveable. In order to avoid cabling issues (e.g. entanglement) the first and second substrate tables will each travel in their own loop. For example, the first substrate table will make a loop which first passes under the pre-wetting station 1200, then under the projection system PS and then under the drying station 130 and then move to a first side of the projection system (i.e. out of the paper in FIG. 7 towards the viewer of the paper). The second substrate table will make a similar loop except that after passing under the dryer 1300, the substrate table will move to a second side of the projection system opposite to the first side (i.e. into the paper in FIG. 7 away from the viewer). In this way entanglement of cables of the first and second substrate tables which provide services to those tables should not occur. Furthermore, the x-y position of the pre-wetter 1200 and/or dryer 1300 can be the same for both substrate tables.

In an embodiment, the pre-wetter 1200 and/or dryer 1300 is elongate and has a length equal to (or more than) the width of the member 1000 and/or the substrate table WT.

During substrate swap the pre-wetter 1200 applies immersion liquid to the top surface of the new substrate table (the second substrate table WT2 as illustrated) as it is moved under the member 1000 which has been fixed relative to the projection system PS. The liquid is provided at a flow rate (which may be adjustable or adaptable) and/or the speed of the substrate table WT is adjusted, to fill the gap with liquid. Thus, a film of liquid is already present on the substrate table and substrate as the substrate table WT2 moves under the member 1000. Thus, immersion liquid can be provided which extends between the top surface of the second substrate table WT2 and the substrate W2 and the surface of the member 1000 which faces the substrate table WT2 and the substrate W2.

The pre-wetter 1200 provides liquid both to the top surface of the substrate table WT2 as well as substrate W2 and any sensor 1015 or other component present under the member 1000. In an embodiment, the pre-wetter 1200 may provide liquid to components which will be under the member 1000 during imaging.

At the other end of the member 1000, where the first substrate table WT1 is moving out from under the member 1000, the dryer 1300 dries the top surface of the substrate table WT1, the substrate WI and any sensor 1015 or other component present under the member 1000. At the end of substrate swap, the pre-wetter 1200 and/or the dryer 1300 may be positioned in preparation for the next substrate swap.

The dryer 1300 and the pre-wetter 1200 can take any form. For example, the dryer 1300 can take the form of a gas drag principle dryer for example, a dryer such as that disclosed in U.S. Ser. No. 11/708,686 filed on Feb. 21, 2007. That document also describes a wetting system which may be used for the pre-wetter 1200.

The immersion liquid between the member 1000 and the substrate table WT and/or substrate W may be stationary (zero flow) relative to the substrate table WT or there may be a liquid flow. The immersion liquid is substantially without gas atmosphere between the member 1000 and the substrate table WT1 and substrate W1. This eliminates splashing and sloshing as well as evaporation and condensation issues and improves reproducability of shear forces among others in the liquid.

A swap bridge such as that described in US Patent publication number US 2007-0216881 A1 may be present between the two substrate tables WT1, WT2. The two substrate tables WT1, WT2 move underneath the member 1000 together. The barrier member 12 may remain activated during substrate swap. This is because the outlet to the barrier member 12 is always blocked by the member 1000. This is advantageous because it is then not necessary to provide a separate shutter member to block the aperture or to provide other means for maintaining the final element of the projection system wet during substrate swap.

Compared with systems on which only a localized area of the substrate is covered in liquid at any one time, the heat load on the substrate and substrate table is reduced. This is because such other systems require extraction of liquid along with gas from a gap between the substrate W and the substrate table WT. This is not required in this present system thereby reducing evaporation heat load.

In an embodiment, the member 1000 is positioned at a distance selected from about 100 μm to 500 μm or larger above the top surface of the substrate table WT1. In an embodiment, the gap is greater than 100 μm high, greater than 200 μm high, greater than 300 μm high, greater than 400 μm high, greater than 500 μm high or greater than 700 μm high. This is achieved for instance by providing one or more protrusions on the top surface of the substrate table WT on which the member 1000 sits thereby to space it away from the top surface of the substrate table WT. The protrusion may include the above described clamping mechanism.

Thickness uniformity of the member 1000 may be significant to avoid overly complicated compensation for thickness variation of the member 1000. Furthermore, it may be necessary to carefully match the refractive index of the transparent material of the member 1000 with the refractive index of the immersion liquid. An embodiment illustrated with reference to FIGS. 9a and 10 may overcome one or more of these difficulties, or other difficulty not mentioned herein, while maintaining one or more of the advantages of the embodiment of FIGS. 7 and 8.

The embodiment of FIGS. 9a and 10 is the same as the embodiment of FIGS. 7 and 8 except as described below. Features described in relation to the embodiment of FIGS. 9a and 10 may also be applied to the embodiment of FIGS. 7 and 8.

As described above, the member 1000 and the substrate table WT move relative to each other in FIGS. 9a and 10. In an embodiment, the substrate table is moved with respect to the member 1000. For example, the member 1000 is substantially stationary relative to the projection system PS. The member 1000 may be connected to a barrier member 12 or may be held substantially stationary relative to the barrier member 12 by being connected to the metrology frame RF or the base frame BF. Some actuation may be present so that the position of the member 1000 may be moved relative to the projection system PS and/or the barrier member 12 and/or metrology frame RF and/or base frame BF. This movement may be parallel and/or perpendicular to the optical axis of the projection system. The barrier member 12 may be of any type which provides liquid to the space between the projection system PS and the substrate. For example, any of the types of liquid supply systems illustrated in FIGS. 2-6 are suitable.

The member 1000 has a through hole 1075 through which the projection beam passes. Positioned within the through hole is a liquid supply system to provide immersion liquid to a space between a final element of the projection system PS and the substrate W and/or the substrate table WT. Therefore, the beam PB of the projection system PS travels through the through hole of the member 1000. In an embodiment, the liquid supply system is in the form of a barrier member, for example barrier member 12 of FIGS. 5 or 6 optionally without liquid confinement. The barrier member 12 sits in the through hole 1075. The barrier member 12 blocks the through hole. The barrier member 12 may be an integral part of the member 1000. The liquid supply system is sealed to the inner periphery of the through hole 1075 in the member 1000. Thereby the liquid in the gap between the member 1000 and the top surface of the substrate table WT and substrate W is not open to the atmosphere. As with the embodiment of FIGS. 7 and 8, the gap between the member 1000 and the substrate table WT and/or substrate W is entirely filled with immersion liquid. Desirably no gas is present in that gap. The immersion liquid extends between the top surface of the substrate table WT and substrate W and the surface of the member 1000 facing the top surface of the substrate table WT and substrate W.

Liquid may be provided to the gap between the member 1000 and the substrate table WT and substrate W by a separate liquid supply system. Alternatively or additionally, the barrier member 12 may be used to provide liquid to that gap. Liquid may only be provided to the gap by a pre-wetter 1200, as discussed above. Liquid may be provided to the gap by a pre-wetter 1200 and during operation liquid is provided to the gap by the barrier member and/or the separate liquid supply system.

As will be appreciated, the barrier member 12 does not need to have perfect sealing characteristics between itself and the top surface of the substrate table WT and/or substrate W because any liquid which leaks between the barrier member 12 and the top surface of the substrate table WT or substrate W simply enters the gap where immersion liquid is present in any case and for which thermal requirements are less stringent. Indeed, in an embodiment it is desirable that the liquid is provided to the gap between the member 1000 and the substrate table WT and/or substrate W by the barrier member 12.

The barrier member 12 provides a liquid to the space between the final element of the projection system and the substrate and/or substrate table. A further liquid supply system is provided to supply liquid to the gap between the member 1000 and the substrate table WT and substrate W. This liquid supply system may be part of the barrier member 12. For example, the outlet 60 illustrated in FIG. 6 could be used to provide liquid to the gap. In that case the sealing and extractor system and features radially outwardly of the outlet 60 illustrated in FIG. 6 are not necessary. In this embodiment the top surface of the substrate W may or may not be co-planar with the top surface of the substrate table WT. In an embodiment, the member 1000 is at least two times the size, in plan, of the substrate table WT. That is, the width and depth (x, y) dimensions of the member 1000 are at least twice the corresponding dimensions of the substrate table WT to accommodate a full scan of the substrate W.

In an embodiment, a first flow of liquid is provided across the space between the final element of the projection system PS and the substrate and/or substrate table WT. This can be provided by inlet 20 in the barrier member 12 of FIG. 6. An outlet in the barrier member, for example outlet 13 or 20, may be provided on the opposite side of the space so that a flow of liquid across the space 11 is present. A second flow of liquid in the gap between the member 1000 and the substrate table WT and/or substrate W can then be provided radially outward of the barrier member 12. The radially outward flow may be provided by supplying liquid to the gap through outlet 60 in the barrier member 12. A liquid flow radially outwardly of the barrier member 12 can be generated by removing the liquid from the gap radially outwardly of the barrier member 12, as will be described below in more detail. The two liquid flows may be kept separate, so desirably liquid from one liquid flow does not substantially mix with liquid from the other liquid flow. The two flows are kept separate because the liquid in the flows may have different physical requirements. For example, the liquid in the first liquid flow is used as in optical component between the last optical element of the projection system and the substrate W. A patterned projection beam may pass through it during exposure. It is desirable for the liquid in the first liquid flow to have good optical qualities to optimally reduce a source of imaging defects. The liquid in the second liquid flow may be used to condition the surface of the substrate, for example, for exposure, and not be used as an optical component. Thus, the same level of control of the physical properties of the liquid in the second liquid flow as for the first liquid flow may be unnecessary. As the liquid in the second liquid flow may be unsuitable for use as an optical component, the two flows should be kept separate.

As with the embodiment of FIGS. 7 and 8, in the instance where the position of the substrate table WT is measured by an interferometer interacting with a mirror attached to the edge of the substrate table, this embodiment provides substantially no problems. However, if the grid plate measurement system is used, this embodiment may provide difficulties. However, different from the embodiment of FIGS. 7 and 8, an error associated with, for example, thickness non-uniformity in the embodiment of FIG. 9a is a measurement error that can be corrected through calibration as opposed to an exposure error in the former embodiment. One way of alleviating this is to provide the grid plate (or plates) as the actual member 1000. Alternatively it may be necessary to measure through the member 1000 onto the grid plate 1500 above the substrate table WT. This is the circumstance illustrated in FIG. 9. The one or more grid plates are attached to the member 1000 via one or more links 1505. One or more actuators 1510 may be provided to help keep the member 1000 in place and/or dynamically decouple member 1000 from the grid plate 1500 and/or metrology frame RF. The member 1000 may experience a large force on it from the moving substrate table transmitted by liquid in the gap.

In order to help optimize the system where the grid plates 1500 and member 1000 are separated, a flow of gas 1550 is provided (radially inwardly) in the gap between the top of the member 1000 and the grid plate 1500. This flow of gas is advantageous because it helps maintain the gap between the member 1000 and the grid plate 1500 clear of contaminants and also helps ensures that the gas in that gap has constant properties (e.g. temperature, pressure, composition, etc.).

The grid plate could be secured, e.g. glued, to the member 1000. The grid plate could be positioned (e.g. attached) relatively to the metrology frame RF or to the base frame BF. If the position of the grid plate relative to the metrology frame RF is measured then the position of the substrate table WT relative to the metrology frame RF may be calculated. Thus, the projection system PS position can also be calculated.

During imaging, the substrate table WT moves under the projection system PS, the barrier member 12 and the member 1000. The projection system PS, barrier member 12 and member 1000 are substantially stationary relative to one another. Therefore, the positions of the member 1000 and substrate table WT relative to each other changes as they move relative to each other. As a consequence the surfaces of the substrate table WT and the member 1000 that define the gap move relative to each other. For this reason a sealing device 1600 is provided which seals between the substrate table WT and the member 1000 radially outwardly of the substrate W. The sealing device confines immersion liquid between the surfaces of the member 1000 and substrate table WT and/or substrate W. In an embodiment, the sealing device 1600 is provided in the substrate table WT. Alternatively or additionally, the sealing device 1600 may be provided on the substrate table carrier 1701 and/or on the member 1000. However, in the latter option this is at the expense of a larger substrate table WT. As can be seen from FIGS. 9a and 10, the sealing device 1600 is desirably mounted adjacent the outermost edge of the substrate table WT. The sealing device 1600 should be mounted such that it encloses all objects on the substrate table WT exposed through immersion liquid and surfaces that may come in contact with immersion liquid. Such objects include the substrate W, sensor 1015, etc.

The sealing device 1600 may be in the form of sealing device such as that illustrated in the bottom of the barrier members 12 of FIG. 5 or 6, in which a meniscus is confined between member 1000 and the sealing device 1600. The sealing device 1600 may be a contactless sealing device. The sealing device 1600 may be a liquid removal device. If the sealing device 1600 is a liquid removal device this helps in creating the radially outward flow of immersion liquid from the barrier member 12.

Therefore, the system is provided with a first liquid removal device to remove liquid from the space between the final element of the projection system and the substrate. That liquid is provided by a first liquid supply device through inlet 20, 13. A second liquid removal system is present to remove liquid from the gap between the surface of the member 1000 facing the substrate table and/or substrate i.e. the (sealing) liquid removal device. The second liquid removal system removes liquid radially outwardly of the substrate W.

The under surface of the member 1000 can be liquidphobic, for example treated, for example with a coating. This makes the task of the sealing device 1600 on the substrate table WT easier. This may be the same as the top surface of the member 1000 of FIGS. 7 and 8.

The gap between the member 1000 and the substrate table WT and/or substrate W is desirably selected from the range of 100 μm to 500 μm or smaller than 100 μm. For example the gap maybe less than 100 μm or less than 50 μm. The distance between the final element of the projection system PL and the substrate is desirably about 3 mm. The distance of the barrier member 12 from the substrate W and/or substrate table WT can be less than the distance between the member 1000 and the substrate W or substrate table WT to create a flow resistance for the optical immersion liquid between the last element of the projection system PS and the substrate table WT and/or substrate W. For example, the barrier member 12 may be only 0.15 mm from the top surface of the substrate W and/or substrate table WT. The member 1000 maybe transparent to the wavelength of radiation used in the grid plate measurement system.

During substrate swap of the embodiment of FIGS. 9 and 10, a pre-wetting station 1200 is used like in the embodiment of FIGS. 7 and 8. This can be done because the member 1000 is stationary relative to the projection system PS. The liquid removal system under the pre-wetting station 1200 is turned off during substrate swap. The first and second substrate tables WT1, WT2 are also coupled together as in the embodiment of FIGS. 7 and 8, desirably through carriers 1701, 1702 of the substrate tables WT1, WT2. The liquid removal system 1600 on the substrate table WT itself can be used to remove the liquid from member 1000. It is advantageous to have a drying station like in the embodiment of FIGS. 7 and 8 to dry the top surfaces of the substrate table WT and substrate W because as the substrate table WT moves from under the member 1000 the liquid in the gap between the member 1000 and the substrate table WT is not necessarily dragged all the way to the liquid removal device 1600 at the edge of the substrate table WT. For this purpose a dryer may be provided, for example such as one or more dryers 1350 in FIG. 10.

In FIG. 10 the grid plate 1500 of FIG. 9a has been omitted for clarity. However, a grid plate would be provided above the member 1000 as well as to the right hand side of the member 1000 as illustrated. The grid plate on the right hand side of the member 1000 is for accurate positioning of the second substrate table WT2. A dryer 1350 is seen as peripherally (e.g., circumferentially) surrounding the member 1000 except for at a portion where the pre-wetter 1200 is located. The dryer 1350 may dry the top surface of the substrate table WT. It will be appreciated that it is not necessary for the dryer 1350 to completely surround the member 1000. For example, the dryer may be provided only part way around the member 1000. In that case the controller of the apparatus controls the substrate table WT such that it only emerges from under the member 1000 at the position where the dryer 1350 is located. The dryer is positioned adjacent an edge of the member 1000. The dryer may even be mounted in or on the member 1000. There may be two pre-wetters 1200 and/or dryers, one for each stage/substrate table.

FIG. 9b illustrates a variation on the embodiment of FIG. 9a in which the member 1000 is the same as the grid plate 1500. FIG. 9b illustrates how forces may be applied to the member 1000/grid plate 1500. The principles and arrangement can be used equally in the embodiment of FIG. 9a.

Because there is a large area of liquid between the member 1000 and the top surface of the substrate table WT, large drag forces can be applied onto the member 1000 by movement of the substrate table WT beneath it. In order to compensate for these forces an actuator 1700 is provided. This actuator acts between the base frame BF (or the metrology frame RF) and the member 1000. A controller 1800 controls the force applied to the member 1000 through actuator 1700. The controller may apply the force to the member 1000 in either a feed-forward or a feed-back manner. Force compensation will generally be by applying a force in a plane substantially parallel to the plane of the member 1000. Height actuation may also be provided. One or more actuators may be provided to activate the barrier member 12 in height. The barrier member 12 may be fixed in a plane perpendicular to the optical axis of the projection system relative to the metrology frame RF.

As is illustrated in FIG. 10, the substrate table WT (or at least the portion that is wetted) is, in plan, smaller, e.g. a great deal smaller, than the member 1000. This is so that the substrate table WT can be moved into a position to allow imaging of all areas of the substrate W and sensor 1015.

In an aspect, there is provided an immersion lithographic apparatus comprising: a substrate table constructed to hold a substrate, a projection system configured to project a patterned radiation beam onto a target portion of a substrate, a member held substantially stationary relative to the projection system and configured to allow passage therethrough of the patterned radiation beam, a surface of the member facing the substrate table, a fluid supply system configured to supply an immersion fluid to a space between the projection system and the substrate and/or substrate table and to provide the immersion fluid to extend between the substrate table and/or substrate and the surface of the member, and a seal device configured to seal between the surface of the member and the substrate table. Optionally, at least part of the member is transparent to electromagnetic radiation used by a position measurement system of the substrate table. Optionally, the seal device is a contactless seal device. Optionally, the seal device comprises a gas inlet and a gas outlet to generate a gas flow to form the seal. Optionally, the seal device is configured to enclose a substrate and/or a sensor on the substrate table. Optionally, the immersion lithographic apparatus further comprises a dryer configured to dry a top surface of the substrate table as it emerges from under the member. Optionally, the member has a size, in plan, greater than the size, in plan, of the substrate table, desirably at least two times. Optionally, the immersion lithographic apparatus further comprises a pre-wetting station configured to apply immersion fluid onto a top surface of the substrate table prior to the substrate table being moved under the member. Optionally, the seal device includes a fluid removal device. Optionally, the member is sized such that during exposure of the substrate, the entire top surface of the substrate is covered in immersion fluid. Optionally, an under surface of the member is liquidphobic to the immersion fluid. Optionally, the immersion lithographic apparatus further comprises a grid plate above the member for use in measuring the position of the substrate table. Desirably, the immersion lithographic apparatus further comprises an outlet configured to provide a gas flow between the grid plate and the member. Optionally, the immersion lithographic apparatus further comprises an actuator configured to apply a force to the member to compensate for a force applied to the member through the fluid. Desirably, the immersion lithographic apparatus further comprises a controller configured to control the force applied by the actuator in a feed-forward manner. Optionally, the seal device is part of the substrate table. Optionally, the substrate table is constructed to hold a substrate such that a top surface of the substrate is substantially co-planar with a top surface of the substrate table. Optionally, the member defines a through hole for the passage therethrough of the patterned radiation beam.

In an aspect, there is provided an immersion lithographic apparatus comprising a substrate table constructed to hold a substrate, a projection system configured to project a patterned radiation beam onto a target portion of a substrate, a member held substantially stationary relative to the projection system and configured to allow passage therethrough of the patterned radiation beam, a surface of the member facing the substrate table, a fluid supply system configured to supply an immersion fluid to a space between the projection system and the substrate and/or substrate table to extend between the substrate table and/or substrate and the surface of the member, a first fluid removal system configured to remove fluid from the space, and a second fluid removal system configured to remove fluid from between the surface of the member and the substrate table at a position outward of the substrate. Optionally, the fluid supply system comprises a first fluid supply system to supply fluid to the space between the projection system and the substrate and/or substrate table and a second fluid supply system to supply fluid between the member and the substrate table and/or the substrate. Desirably, the fluid supply systems and the fluid removal systems are configured so that the fluid supplied by the first fluid supply system is substantially entirely removed by the first fluid removal system. Desirably, the fluid supply systems and the fluid removal systems are configured so that the fluid supplied by the second fluid supply system is substantially entirely removed by the second fluid removal system. Optionally, the fluid supply system and the first fluid removal system co-operate to form a flow of fluid across the space. Optionally, the fluid supply system and the second fluid removal system co-operate to generate a substantially radially outwardly flow of fluid. Optionally, the second fluid removal system is effective to seal fluid between the member and the substrate table and/or substrate. Optionally, the second fluid removal system is in the substrate table. Optionally, the second fluid removal system is in the member. Optionally, the member is transparent to radiation used by a position measurement system for the substrate table.

In an aspect, there is provided an immersion lithographic apparatus comprising a substrate table constructed to hold a substrate, a member with a surface facing the substrate table, a pre-wetting station configured to provide immersion fluid onto a surface of the substrate and/or substrate table prior to the substrate and/or substrate table moving under the member such that the immersion fluid extends between the surface of the substrate and/or substrate table and the surface of the member facing the substrate table. Optionally, the immersion lithographic apparatus further comprises fluid remover configured to remove fluid from a surface of the substrate and/or substrate table as the substrate table moves from underneath the member. Optionally, the pre-wetting station is elongate and has a length equal to a plan width of the member or a fluid remover.

In an aspect, there is provided an immersion lithographic apparatus comprising a substrate table constructed to hold a substrate, a member with a surface facing the substrate table, and a fluid remover configured to remove fluid from a surface of the substrate and/or substrate table as the substrate and/or substrate table moves from underneath the surface of the member during movement of the substrate from under the member. Optionally, the fluid remover is positioned in or on or adjacent the member. Optionally, the fluid remover is configured to remove fluid from the surface of the substrate and/or substrate table as the substrate and/or substrate table moves from underneath the surface of the member during movement of the substrate from under the member following exposure.

In an aspect, there is provided an immersion lithographic apparatus comprising a first substrate table constructed to hold a substrate, and a second substrate table constructed to hold a substrate, wherein the first and second substrate tables are releasably attachable together. Optionally, the substrate tables each comprise a sensor.

In an aspect, there is provided a method of providing a substrate under a projection system of an immersion lithographic apparatus, the method comprising moving a substrate on a substrate table under an elongate pre-wetting station which provides an immersion fluid on a top surface of the substrate and/or substrate table, and moving a pre-wet portion of the substrate and/or substrate table under a member which is held substantially stationary relative to the projection system such that immersion fluid extends between a surface of the member facing the substrate and/or substrate table and the substrate and/or substrate table.

In an aspect, there is provided a method of removing a substrate table from under a projection system of an immersion lithographic apparatus, the method comprising moving a substrate on a substrate table from under a member which is held substantially stationary relative to the projection system, and using a fluid removing device located over a portion of the substrate table which emerges as the substrate table is moved from under the member to remove fluid from the portion. Optionally, the using includes positioning the fluid removing device over a portion of the substrate table which emerges as the substrate table is moved from under the member to remove fluid from the portion.

In an aspect, there is provided an immersion lithographic apparatus comprising a substrate table constructed to hold a substrate, a projection system configured to project a patterned radiation beam onto a target portion of a substrate, a member held substantially stationary relative to the projection system and configured to allow passage therethrough of the patterned radiation beam, a surface of the member facing the substrate table, a fluid supply system configured to supply a substantially incompressible immersion fluid to a space between the projection system and the substrate and/or substrate table and between the substrate table and/or substrate and the surface of the member, and a seal device configured to seal between the surface of the member and the substrate table.

In an aspect, there is provided an immersion lithographic apparatus comprising a substrate table constructed to hold a substrate, a projection system configured to project a patterned radiation beam onto a target portion of a substrate, a member held substantially stationary relative to the projection system and configured to allow passage therethrough of the patterned radiation beam, a surface of the member facing the substrate table, a fluid supply system configured to supply an immersion fluid to a space between the projection system and the member and to supply an immersion fluid to a space between the member and the substrate and/or substrate table to extend between the substrate table and/or substrate and the surface of the member, and a seal device configured to seal between the surface of the member and the substrate table.

In an aspect, there is provided an immersion lithographic apparatus comprising a substrate table constructed to hold a substrate, a projection system configured to project a patterned radiation beam onto a target portion of a substrate, a member held substantially stationary relative to the projection system and configured to allow passage therethrough of the patterned radiation beam, a surface of the member facing the substrate table, a fluid supply system configured to supply a substantially incompressible immersion fluid to a space between the projection system and the substrate and/or substrate table and to further supply a substantially incompressible immersion fluid between the substrate table and/or substrate and the surface of the member, and a seal device configured to seal between the surface of the member and the substrate table.

In an aspect, there is provided an immersion lithographic apparatus comprising a substrate table constructed to hold a substrate such that a top surface of the substrate is substantially co-planar with a top surface of the substrate table, a projection system configured to project a patterned radiation beam onto a target portion of a substrate, a member held substantially stationary relative to the projection system and with a through hole for the passage therethrough of the patterned radiation beam, a surface of the member facing the substrate table, a fluid supply system configured to supply an immersion fluid to a space between a final element of the projection system and the substrate and/or substrate table and to provide immersion fluid to extend between the substrate table and/or substrate and the surface of the member, and a seal device in the substrate table configured to seal between the surface of the member and the substrate table.

In an aspect, there is provided an immersion lithographic apparatus comprising a substrate table constructed to hold a substrate such that a top surface of the substrate is substantially co-planar with a top surface of the substrate table, a projection system configured to project a patterned radiation beam onto a target portion of a substrate, a member held substantially stationary relative to the projection system and with a through hole for the passage therethrough of the patterned radiation beam, a surface of the member facing the substrate table, a fluid supply system configured to supply a substantially incompressible immersion fluid to a space between a final element of the projection system and the substrate and/or substrate table and between the substrate table and/or substrate and the surface of the member, and a seal device in the substrate table configured to seal between the surface of the member and the substrate table.

In an aspect, there is provided an immersion lithographic apparatus comprising a substrate table constructed to hold a substrate, a projection system configured to project a patterned radiation beam onto a target portion of a substrate, a member held substantially stationary relative to the projection system and configured to allow passage therethrough of the patterned radiation beam, a surface of the member facing the substrate table, a first fluid supply system to supply an incompressible fluid to a space between the projection system and the substrate and/or substrate table, a second fluid supply system to supply an incompressible fluid between the member and the substrate table and/or the substrate, a first fluid removal system configured to remove fluid from the space, and a second fluid removal system configured to remove fluid from between the surface of the member and the substrate table at a position outward of the substrate.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controllers described above may have any suitable configuration for receiving, processing, and sending signals. For example, each controller may include one or more processors for executing the computer programs that include machine-readable instructions for the methods described above. The controllers may also include data storage medium for storing such computer programs, and/or hardware to receive such medium.

One or more embodiments of the invention may be applied to any immersion lithography apparatus, in particular, but not exclusively, those types mentioned above and whether the immersion liquid is provided in the form of a bath, only on a localized surface area of the substrate, or is unconfined on the substrate and/or substrate table. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

1. An immersion lithographic apparatus comprising:
a substrate table constructed to hold a substrate;
a projection system configured to project a patterned radiation beam onto a target portion of a substrate;
a member held substantially stationary relative to the projection system and configured to allow passage therethrough of the patterned radiation beam, a surface of the member facing the substrate table;
a fluid supply system configured to supply an immersion fluid to a space between the projection system and the substrate and/or substrate table and to provide the immersion fluid to extend between the substrate table and/or substrate and the surface of the member; and
a seal device configured to seal between the surface of the member and the substrate table.

2. The immersion lithographic apparatus of claim 1, wherein at least part of the member is transparent to electromagnetic radiation used by a position measurement system of the substrate table.

3. The immersion lithographic apparatus of claim 1, wherein the seal device is a contactless seal device.

4. The immersion lithographic apparatus of claim 1, wherein the seal device comprises a gas inlet and a gas outlet to generate a gas flow to form the seal.

5. The immersion lithographic apparatus of claim 1, wherein the seal device is configured to enclose a substrate and/or a sensor on the substrate table.

6. The immersion lithographic apparatus of claim 1, further comprising a dryer configured to dry a top surface of the substrate table as it emerges from under the member.

7. The immersion lithographic apparatus of claim 1, wherein the member has a size, in plan, greater than the size, in plan, of the substrate table, desirably at least two times.

8. The immersion lithographic apparatus of claim 1, further comprising a pre-wetting station configured to apply immersion fluid onto a top surface of the substrate table prior to the substrate table being moved under the member.

9. The immersion lithographic apparatus of claim 1, wherein the seal device includes a fluid removal device.

10. The immersion lithographic apparatus of claim 1, wherein the member is sized such that during exposure of the substrate, the entire top surface of the substrate is covered in immersion fluid.

11. The immersion lithographic apparatus of claim 1, wherein an under surface of the member is liquidphobic to the immersion fluid.

12. The immersion lithographic apparatus of claim 1, further comprising a grid plate above the member for use in measuring the position of the substrate table.

13. The immersion lithographic apparatus of claim 12, further comprising an outlet configured to provide a gas flow between the grid plate and the member.

14. The immersion lithographic apparatus of claim 1, further comprising an actuator configured to apply a force to the member to compensate for a force applied to the member through the fluid.

15. The immersion lithographic apparatus of claim 14, further comprising a controller configured to control the force applied by the actuator in a feed-forward manner.

16. The immersion lithographic apparatus of claim 1, wherein the seal device is part of the substrate table.

17. The immersion lithographic apparatus of claim 1, wherein the substrate table is constructed to hold a substrate such that a top surface of the substrate is substantially co-planar with a top surface of the substrate table.

18. The immersion lithographic apparatus of claim 1, wherein the member defines a through hole for the passage therethrough of the patterned radiation beam.

19. An immersion lithographic apparatus comprising:
a substrate table constructed to hold a substrate;
a projection system configured to project a patterned radiation beam onto a target portion of a substrate;
a member held substantially stationary relative to the projection system and configured to allow passage therethrough of the patterned radiation beam, a surface of the member facing the substrate table;
a fluid supply system configured to supply an immersion fluid to a space between the projection system and the substrate and/or substrate table to extend between the substrate table and/or substrate and the surface of the member;
a first fluid removal system configured to remove fluid from the space; and
a second fluid removal system configured to remove fluid from between the surface of the member and the substrate table at a position outward of the substrate.

20.-42. (canceled)

43. An immersion lithographic apparatus comprising:
a substrate table constructed to hold a substrate such that a top surface of the substrate is substantially co-planar with a top surface of the substrate table;
a projection system configured to project a patterned radiation beam onto a target portion of a substrate;
a member held substantially stationary relative to the projection system and with a through hole for the passage therethrough of the patterned radiation beam, a surface of the member facing the substrate table;
a fluid supply system configured to supply an immersion fluid to a space between a final element of the projection system and the substrate and/or substrate table and to provide immersion fluid to extend between the substrate table and/or substrate and the surface of the member; and
a seal device in the substrate table configured to seal between the surface of the member and the substrate table.

44-45. (canceled)
